(19) United States
(12) Patent Application Publication
(10) Pub. No.: US 2002/0173303 A1
(43) Pub. Date: Nov. 21, 2002

(54) Wireless communication system

(75) Inventor: Akira Shibutani, Sunnyvale, CA (US)

Correspondence Address: Tadashi Horie, Brinks Hofer Gilson & Lione, P.O. Box 10395, Chicago, IL, 60610, US

(73) Assignee: DoCoMo Communications Laboratories USA, Inc.

(21) Appl. No.: 09/858,706

(22) Filed: May 16, 2001

(51) Int. Cl. H04Q 7/20

(52) U.S. Cl. 455/426; 455/552

(57) ABSTRACT

The present invention provides a wireless communication system that comprises a plurality of communication networks operating with different communication parameters and protocols and at least one communication terminal having multiple communication modules each adapted to operate with specific communication parameters and protocol for access to at least one corresponding communication network operating with the same communication parameters and protocol. A module in the communication terminal is activated to prepare for communication with the corresponding network when it is expected likely that the communication terminal is heading to access the corresponding network. The activated module is deactivated when the same is expected unlikely. The communication terminal is usually battery-powered. Since modules are deactivated when not necessary, the battery life can be prolonged.

### BACKGROUND OF THE INVENTION

This invention relates generally to the field of wireless digital communication systems comprised of a plurality of networks operating with different communication parameters and protocols and, more particularly, to activation and deactivation of communication modules in a mobile terminal traveling in such systems.

The growing dependence on instantaneous personal communication devices is creating huge demand for global wireless communication capabilities. The role of wireless had gone well beyond the traditional voice and paging mobile radio services of a few short years ago. But rapid expansion of wireless service providers, diversity of air interfaces and technological progress have led to numerous widely disparate wireless systems, multiple standards and a mix of radio frequency bands throughout the world. Today's digital cellular and Personal Communication System (PCS) networks use a variety of digital technologies for the air interface link between the terminal and network, and embrace a number of communication standards and protocols. The divergent standards and protocols often frustrate business travelers who communicate with their customers or offices while traveling form one network to another because they cannot use the same device without significant enhancements/adjustments to deal with incompatible systems. To add to the complexity, the wireless industry is in the throes of migrating from the second generation (2G) to next generations (3G and beyond) of these standards, as well as introducing technologies such as GPS for location services, Bluetooth for local communications, and the like.

Efforts have been made to create unified standards for wireless communication. The broadest international effort is under the auspices of the International Telecommunication Union (ITU). Its IMT-2000 activity, considering the third generation mobile system (3G), has made substantial progress in identifying common goals and functions, but seems unlikely to achieve a single worldwide operating standard or common frequency bands.

In the meantime, the rapidly advancing intergraded circuit technologies have given rise to the advent of wireless communication terminals having multiple communication modules. Each of the communication modules is designed and configured to operate with specific communication parameters and protocol so as to tap into a particular network using the same parameters and protocol for communication. These multi-communication terminals may be the best practical solution when a new communication standard is being adapted and replacing an old standard. These multi-communication terminals enable wireless operators to continue serving subscribers with subscribing agreements effective under the old standard, while allowing the operators to introduce the new technology to the same subscribers. More practical use of these multi-communication terminals may be found in a situation where a corporation builds its own private wireless network within a public wireless network. These multi-communication terminals eliminate the inconvenience of the employees of the corporation who would otherwise have to carry two different communication terminals for access to the public network and private network.

### BRIEF SUMMARY OF THE INVENTION

The present invention provides a wireless communication system that comprises a plurality of communication networks operating with different communication parameters and protocols and at least one communication terminal having multiple communication modules each adapted to operate with specific communication parameters and protocol for access to at least one corresponding communication network operating with the same communication parameters and protocol. A module in the communication terminal is activated to prepare for communication with the corresponding network when it is expected likely that the communication terminal is heading to access the corresponding network. The activated module is deactivated when the same is expected unlikely. The communication terminal is usually battery-powered. Since modules are deactivated when not necessary, the battery life can be prolonged.

In the present invention, it is judged likely, when the communication terminal has entered a first predefined zone, that the communication terminal is heading to access the corresponding network, and the same is judged unlikely when the communication terminal has left a second predefined zone. The first zone is defined such that it is reasonably inferred from the fact that the communication terminal has entered the first zone that the communication terminal is heading to access the corresponding network. The second zone is defined such that it is reasonably inferred from the fact that the communication terminal is not heading to access the corresponding network.

Usually, a wireless network forms at least one communication area comprised of a plurality of cells. The first zone is defined by a chain of cells encompassing the communication area formed by the corresponding network. The second zone is defined by the same chain of cells or a chain of cells encompassing the first zone. At least one of the first and second zones may be defined by cells in networks that overlap with the communication area formed by the corresponding network. Alternatively, at least one of the first and second zones may be defined by first cells adjacent to second cells in networks that overlap with the communication area formed by the corresponding network.

At least one of the first and second zones may be defined by a communication area of a network that lies on a route necessarily leading to the communication area formed by the corresponding network.

A network other than the corresponding network may initiate at least activation of the module if the network has information on the location of at least the first zone. In such an arrangement, the network obtains information, at the time of a hand-off by the communication terminal, that the communication terminal is equipped with the module.

The communication terminal may at least activate the module if it has information on the location of at least the first zone. The information may be updated when the communication terminal for the first time enters the first zone for a newly build network. The communication terminal may obtain information on its location at the time of a hand-off thereby.

Alternatively, the corresponding network may initiate at least activation of the module if it has information on the location of at least the first zone. In such an arrangement, the corresponding network may obtain information on the location of the communication terminal from the communication terminal or the primary network of the communication terminal.

At least one of the modules in the communication terminal may be a communication module defined by software. The software may be downloaded on the module when the module is activated. At least one of the modules in the communication terminal may be a communication module defined by communication parameters. The communication parameters may be downloaded on the module when the module is activated.

### BRIEF DESCRIPTION OF SEVERAL VIEWS OF THE DRAWINGS

FIG. 1 is a graphical representation of a third generation wireless, mobile access, IP network in which the present invention is intended to operate;

FIG. 2 is a simplified graphical representation showing hand-off operations by a mobile terminal;

FIG. 3 is a block diagram showing a mobile terminal used in the system according to the present invention;

FIG. 4 is a simplified graphical representation of networks according to the present invention in which the mobile terminal shown in FIG. 3 travels;

FIG. 5A is a flow chart showing operations according to the present invention for activating and deactivating a module in the communication terminal;

FIG. 5B is a flow chart showing operations according to another embodiment of the present invention for activating and deactivating modules in the communication terminal;

FIG. 5C is a flow chart showing operations for activating a deactivated module to receive a call;

FIG. 6 is a simplified graphical representation showing a regional communication area (R) that overlaps with three cells of another network;

FIG. 7 is a simplified graphical representation of networks according to the present invention in which the mobile terminal shown in FIG. 3 travels; and

FIG. 8 is a simplified graphical representation of networks according to the present invention in which a network is newly built.

### DETAILED DESCRIPTION OF THE INVENTION

The presently preferred embodiments of the invention are described herein with reference to the drawings, wherein like components are identified with the same references. The descriptions of the preferred embodiments contained herein are intended to be exemplary in nature and are not intended to limit the scope of the invention.

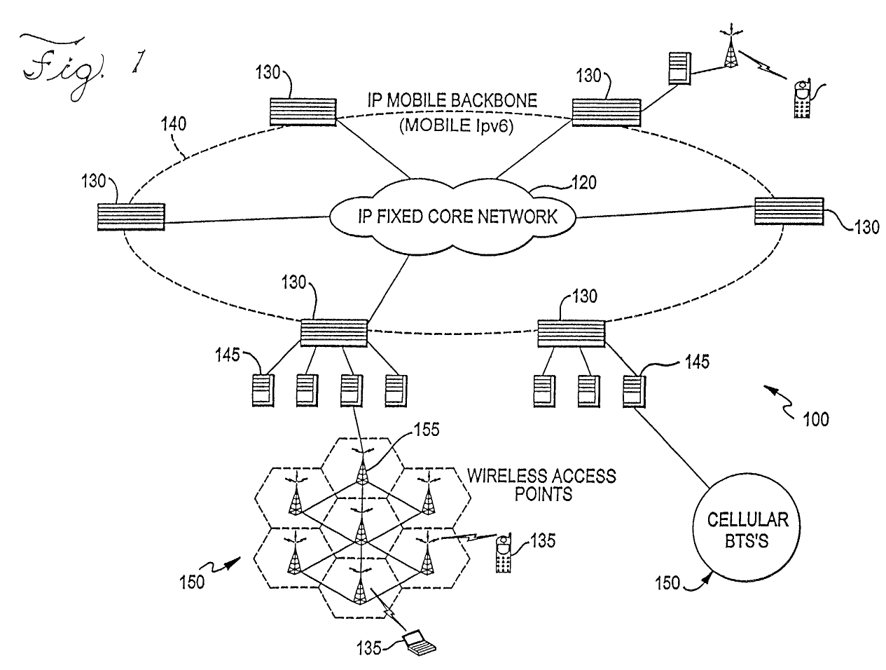

FIG. 1 illustrates graphically an exemplary wireless, mobile access network 100 in which the invention is intended to find application. The network 100 may be a second generation (2G) network, or a 3G or beyond network, to any of which the present invention is applicable. For purposes of the present description, it is assumed the data network 100 adheres to the IMT-2000 standards and specifications of the ITU for wireless, mobile access networks. These standards propose so-called third generation (3G) and beyond (i.e., 3.5G, 4G etc.) data networks that include extensive mobile access by wireless, mobile terminals including cellular phones, personal digital assistants (PDAs), handheld computers, and the like. (See http://www.itu.int). The proposed third generation and beyond networks support IP based data communication, i.e., all data is communicated in digital form via Internet addressing and routing protocols from end to end. Additionally, it is assumed the data network 100 implements Mobile IP support according to the proposed standards of the IETF. These proposed standards for IP Mobility Support include IETF RFC 2002, also referred to as Mobile IP Version 4 (IPv4), and draft working document “draft-ietf-mobileip-ipv6-13”, entitled “Mobility Support in IPv6,” also referred to as Mobile IP Version 6, both of which are incorporated herein by reference.

The wireless, mobile access, IP network 100 has as its core a fixed node IP data network 120 comprising numerous fixed nodes (not shown), i.e., fixed points of connection or links. Digital data is communicated within and over the network in accordance with Internet protocols such as Internet protocol version 6, specified as IETF RFC 2460, which is incorporated herein by reference. Built on the core network 120 is a collection of gate routers 130 which collectively form an IP mobile backbone 140 and function, in accordance with the conventional Internet addressing and routing protocols, to route packets of data between source and destination nodes connected to the network. The gate routers 130 forming the IP mobile backbone 140 are themselves nodes of the core network 120 and have unique IP addresses for communication over the core network 120. Connected to each of the gate routers 130 is servers or routers 145, which also have unique IP addresses and function as home agents (HA) and foreign agents (FA) to interface mobile terminals 135 to the core network 120, as specified in IETF RFC 2002 (“Mobile IP Version 4”), which has been incorporated herein by reference. The mobile terminals 135 are wireless communication devices including cellular handsets, cellular telephones, hand-held computers, personal information managers, wireless data terminals, and the like.

Some of the agents 145 have a base transceiver station network 150 by way of which the mobile terminals 135 communicate with the network 100. Each of the base transceiver station networks 155 comprises a multiple base transceiver stations (BTSs) 155. The mobile terminals 135 and the BTSs employ known CDMA, W-CDMA or similar digital data communication technology to communicate with each other. The construction, arrangement, and functionality of the BTS networks 150 or BTSs 155 are conventional and standard. Similarly, the implementation of CDMA, W-CDMA or similar digital data communication technology in wireless, mobile terminals 135 and BTSs 155 is standard. Detailed description thereof is not necessary to a complete understanding and appreciation of the present invention and is therefore omitted.

Within the overall data network 100, three levels of mobile terminal mobility are contemplated. Macro-mobility refers to a change in location of a mobile terminal such that it leaves its home network and enters a network served by another agent. In other words, the mobile terminal's link or connection to the data network changes from one agent to another. Macro-mobility encompasses changes between a home and foreign agent or between foreign agents, and is also called inter-agent mobility. Intermediate mobility refers to a change in location of a mobile terminal wherein its link to the network changes from one BTS network to another. Finally, micro-mobility refers to a change in location of a mobile terminal within a BTS network 150, in which case the mobile terminal's network link does not change. In the context of the present example, the invention is applied in connection with the micro-mobility level. The handling of micro-mobility are well known in wireless, cellular communication networks. For example, it is well known to use beacon signal strength for detecting and handling communication hand-offs between BTSs when a mobile terminal 135 changes location on a micro-mobility scale.

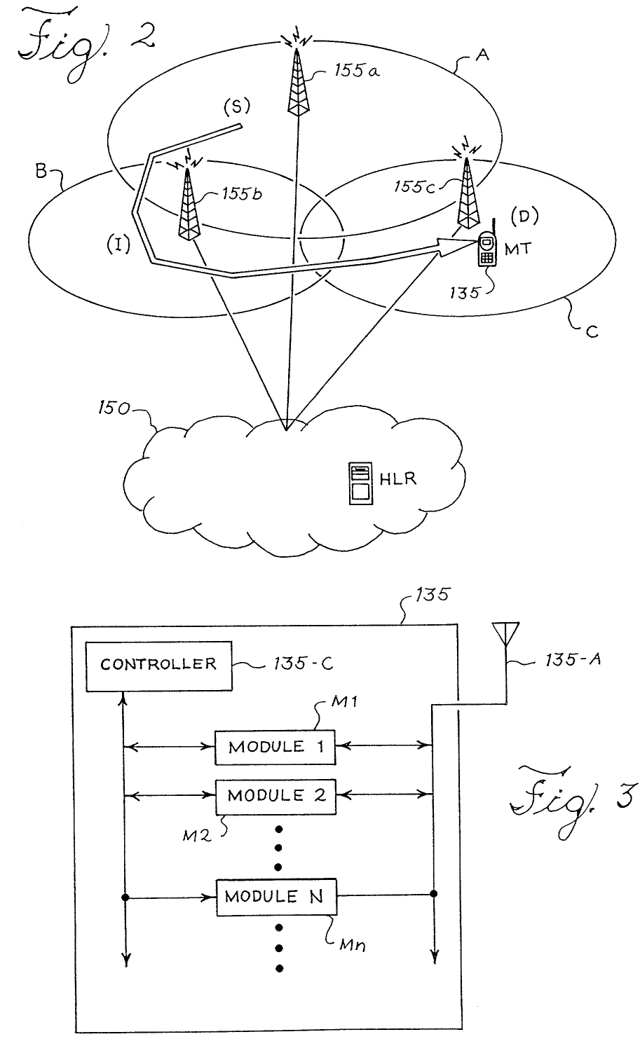

FIG. 2 provides a simplified graphical illustration showing micro-mobility and hand-off processes in a BTS network 150. In FIG. 2, the network 150 includes BTS 155a, 155b and 155c forming individual radio zones (“cells”) A, B and C, respectively. There are other BTSs 155 provided in the network 150, which are not shown in FIG. 2. Each of the BTSs 155a-155c is identified by a unique BTS number. The BTSs may be identified by their IP addresses if the network 100 adopts the 3rd or beyond generation standards. The network 150 also includes a home location register (HLR). The HLR registers all the mobile terminals whose primary connection network is the network 150. The HLR performs authentication of these registered mobile terminals and maintains information on the locations of the mobile terminals.

It is assumed that a mobile terminal (MT) 135 travels along a route as shown in FIG. 2, starting at a starting location (S) through an intermediary location (I) towards a destination (D). The starting location is located within the cell A formed by the BTS 155a. The intermediary location (I) is located within the cell B formed by the BTS 155b. The destination (D) is located within the cell C formed by the BTS 155c. A hand-off occurs when the MT 135 is leaving the cell A and entering the cell B. Likewise, another hand-off occurs when the MT 135 is leaving the cell B and entering the cell C. The hand-off process generally consists of four steps. The first step is a triggering step in which a MT detects that a handoff is imminent, based on the facts that the strength of the beacon signals from the source BTS becomes too low, and/or interference or bit error rate becomes too high. In the second step, the MT searches for candidate BTSs for hand-off by measuring the strengths of the beacon signals from the surrounding BTSs. The third step is a selection step where the MT selects one of the candidate BTSs as a target BTS. Before selecting a target BTS, the MT must decide if any better choice is available, and if a hand-off is worthwhile. Lastly, the MT establishes connection with the target BTS and then disconnect itself from the source BTS.

In FIG. 2, as the MT 135 travels along the route, at some point between the starting location (S) and the intermediary location (I), the beacon signal from the BTS 155a begins to degrade and the error rate on the data received from the BTS 155a begins to rise. Recognizing that a hand-off from the BTS 155a is imminent, the MT 135 measures the beacon signals from the surrounding BTSs including the BTS 155b. Based on the strengths of the beacon signals from the surrounding BTSs, the MT 135 selects a target BTS to which it is to hand-off. It is assumed that the MT 135 selects the BTS 155b as a target BTS from the candidate BTSs.

If the MT 135 detects that the beacon signal from the BTS 155a begins to degrade, it has to begin hand-off operations and finish them before it completely loses the BTS 155a. The MT 135 sends a request for connection to the BTS 155b. In response, the BTS 155b makes an inquiry to the HLR as to whether the MT 135 is authorized to communicate within the network 150. It is assumed that the primary network for the MT 135 is the network 150 and thus the HLR has the registered information on the MT 135. Therefore, in reply to the request from the BTS 155b, the HRL authenticates the MT 135 to the BTS 155b. The BTS 155b thus will allow the MT 135 to hand-off to itself. The MT 135 first establishes connection with the BTS 155b and then disconnects itself from the BTS 155a. In parallel to the disconnection and connection operations by the MT 135, the BTS 155b reports to the HLR that the MT 135 has handed-off to the BTS 155b. Receiving the report from the BTS 155b, the HLR updates the location information of the MT 135, i.e., the HLR stores the BTS number of the BTS 155b in relation to the MT 135, thereby indicating that the MT 135 is currently found in the cell B. The MT 135 continues to travel from the intermediary location (I) towards the destination (D). The hand-off operations between the BTSs 155b and 155c are the same as already discussed above and thus descriptions thereof are omitted to avoid redundancy.

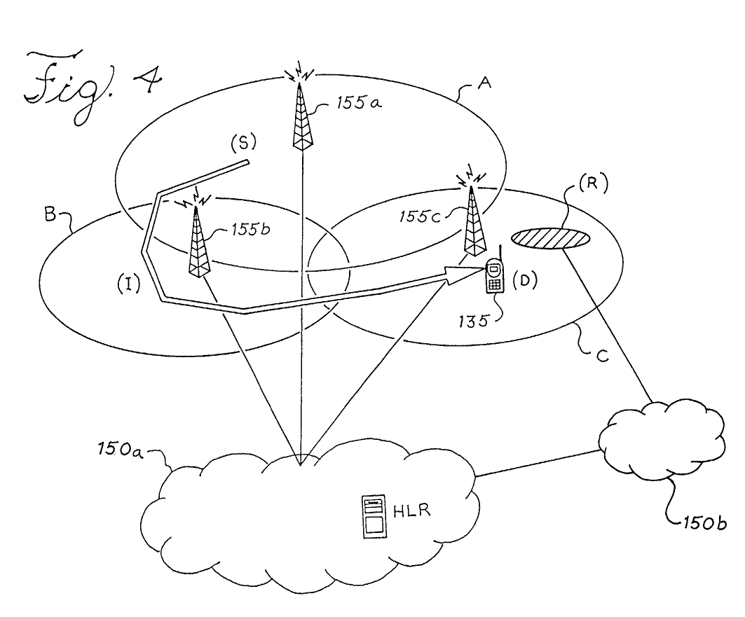

The recent phenomenal expansion of wireless service providers, diversity of air interfaces and technological progress have led to numerous widely disparate wireless systems, multiple standards and a mix of radio frequency bands. In response, some MTs 135 have multiple communication modules to be able to access different networks operating with different frequency bands and different communication protocols. FIG. 3 is a block diagram of a MT 135 having multiple communication modules. The MT 135 shown in FIG. 3 includes communication modules M1-Mn each adapted to communicate with a different network through a single multi-band antenna 135-A. Each module may have its own antenna designed for a specific radio frequency. Each communication module is designed and configured to perform communication, according to specific communication parameters and protocols, so as to be able to access a particular network operating with the same specific parameters and protocols. In this embodiment, the communication parameters include a radio bandwidth, a radio frequency, a coding rate, a modulation level, a bit rate, etc. The MT 135 also includes a controller 135-C for controlling the communication modules M1-Mn and other functionalities in the MT 135. The controller 135-C selectively activates or deactivates the communication modules M1-Mn.

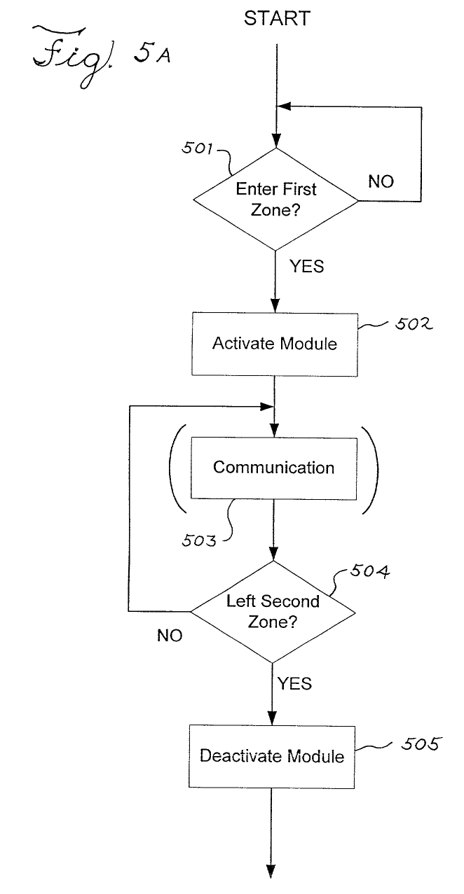

The detailed operations of a preferred embodiment according to the present invention will be described with reference to FIG. 4. FIG. 4 is a simplified graphical representation showing a communication system including two different wireless networks co-existing within the same area. In FIG. 4, a wireless network 150a, like the network 150 as shown in FIG. 3, includes three BTSs 155a-155c forming cells A-C, respectively. The wireless network 150a may be a public wireless network. As in FIG. 3, a mobile terminal (MT) 135 travels from a starting location (S), which is located within the cell A, through an intermediary location (I), which is located within the cell B, towards a destination (D), which is located within the cell C. The difference from FIG. 3 is that in FIG. 4, another wireless network 150b is present and forms a regional communication area (R) within the cell C of the network 150a. The network 150b may be a private corporate network specially designed to connect satellite business areas of a corporation. For the purpose of this embodiment, it is assumed that the networks 150a and 150b use different communication parameters and protocols. It is also assumed that in the MT 135 as shown in FIG. 3, the communication module M1 is adapted to communicate with the network 150a, and the communication module M2 is adapted to communicate with the network 150b. Therefore, while in the cells A-C, the MT 135 can access the network 150a, using the communication module M1. When in the regional communication area (R), the MT can tap directly into the network 150b, using the communication module M2. The networks 150a and 150b are connected through a custom line or the Internet so that data communication is possible between them. Therefore, even if the MT 135 is not in the region (R), the MT 135 and the network 150b can communicate in directly through the network 150a if the MT 135 is in any of the cells A-C.

An important feature of the present invention is that the communication modules in the MT 135 are usually deactivated and selectively activated only when necessary. Mobile terminals are usually battery-powered. The communication modules are deactivated when not necessary to prolong the battery life. Also, in the present invention, activation or deactivation of communication modules is initiated by predicting a future travel route to determine whether communication needing a particular communication module is likely or unlikely. For these purposes, in the present invention, there are two zones are predefined. A first zone is defined such that it is reasonably inferred from the fact the TM 135 has entered the zone that the TM is heading to access a particular network. A second zone is defined such that it is reasonably inferred from the fact the TM 135 has left the zone that the TM is not heading to access the particular network. Also, the second zone is defined as equal to the first zone or larger than and encompassing the first zone. There are three players in the present invention to initiate activation or deactivation of the communication modules in the MT 135: the network 150a; the network 150b; and the TM 135 itself.

Returning to the example shown in FIG. 4, a first preferred embodiment according to the present invention will be explained. In FIG. 4, the MT 135 is traveling from the starting location (S) through the intermediary location (I) towards the destination (D). If the MT 135, purporting to access the network 150b, heads for the regional communication area (R) after passing the destination (D), the communication module M2 must be activated at some point along the route where access to the network 150b is judged likely. Also, at some point after communication with the network 150b, the module M2 must be deactivated to save the battery power. In this first embodiment, the first zone and the second zone are both defined in concurrence with the cell C. Therefore, in the example as shown in FIG. 4, when the TM 135 enters the cell C, the communication module M2 is activated, and the module M2 is deactivated when the TM leaves the cell C.

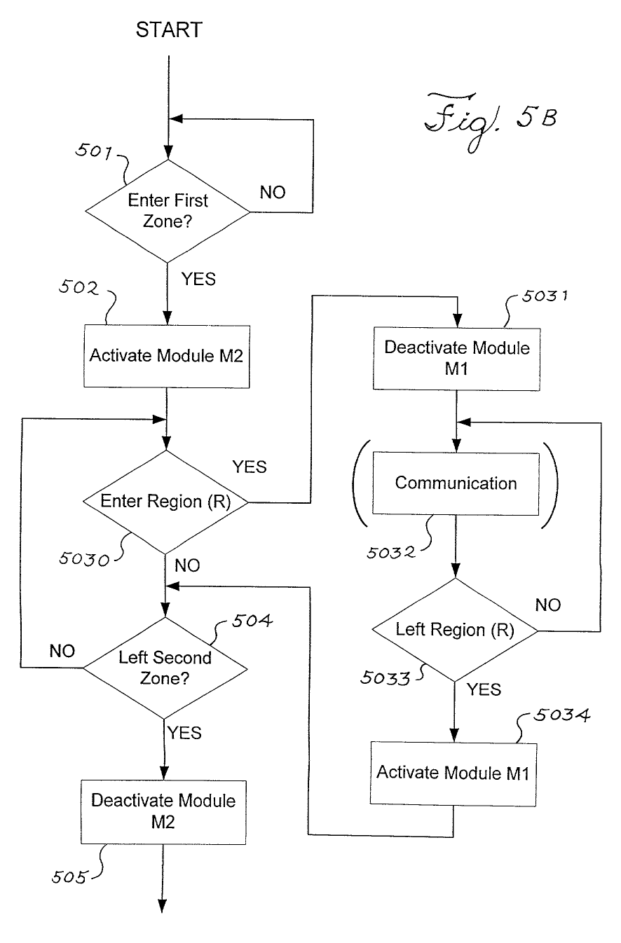

FIG. 5A is a flowchart showing the operations according to the first embodiment of the present invention. In this embodiment, initiation of activation and deactivation of the communication module M2 is performed by the network 150a. Also, each of the BTS in the network 150a has information as to whether its own cell overlaps with any communication area formed by a different network. Thus, in FIG. 4, the BTS 155c has information that the regional communication area (R) is formed within its cell C by the network 150b.

In Step 501, it is determined whether the MT 135 has entered the first zone, i.e., the cell C. While traveling from (S) to (I) to (D), the MT performs a hand-off operations twice: the first one is from the BTS 155a to the BTS 155b; and the second one is from the BTS 155b to the BTS 155c. At each of the hand-offs, the MT 135 sends the target BTS information on what communication modules are equipped in the MT 135. When receiving the information, the target BTS determines if any of the communication modules equipped in the MT 135 is adapted to access any network that forms a communication area overlapping with its cell. Thus, at the hand-off from the BTS 155b to the BTS 155c, the BTS 155 c learns that the MT 135 has the module M2, which is adapted to access the network 150b. The BTS 155c then instructs the MT 135 to activate the module M2 at the hand-off. According to the instruction from the BTS 155c, the MT 135 activates the module M2 (Step 502).

The information as to what communication modules are equipped in the MT 135 may be obtained from the HLR in the network 150a. The HLR has authentication information on the MT 135 that may include the information on what communication modules are equipped. As discussed above, at each of the hand-offs, the target BTS 155, i.e., the BTS 155b or 155c, requests the HLR to authenticate the MT 135. In authenticating the MT 135 to the target BTS, the HLR may send the target BTS information on what communication modules are equipped in the MT 135. The target BTS thereby learns from the HLR that the MT 135 has the module M2.

The MT 135 may move into the regional communication area (R) to begin communication with the network 150b (Step 503). Or the MT 135 may not visit the region (R). In any case, the module M2 in the MT 135 keeps activated as long as the MT 135 is found within the cell C. When the MT 135 begins the hand-off operations to another BTS, the BTS 155c learns (Step 504) that the MT 135 is leaving the cell C. During the hand-off operations, the BTS 155c instructs the MT 135 to deactivate the module M2 in the MT 135 (Step 505).

In the above embodiment, each of the BTS in the network 150a has information as to whether its own cell overlaps with any communication area formed by a different network. That information may be stored, not in the BTSs, but in the HLR or other service nodes. Thus, the HLR or other service nodes may have the information on which cells of the network 150a overlap with communication areas formed by other networks. In such an arrangement, the HLR or other service nodes determine at each hand-off whether the MT 135 is entering a cell that overlaps with any communication area formed by another network which any of the modules in the MT can access. Therefore, in the example shown in FIG. 4, the HLR or other service nodes determine at the hand-off from the cell B to the cell C that the cell C has the communication region (R) in which the module M2 of the MT 135 can access the network 150c. In addition to sending the authentication information to the BTS 155c, the HLR or other service nodes instruct the MT 135 through the BTS 155c to activate the module M2. Likewise, when the MT 135 is leaving the cell C, the HLR or other service node instruct the MT 135 to deactivate the module M2.

Step 503 in FIG. 5A may be replaced by Steps 5030-5034 shown in FIG. 5B. In FIG. 5B, the module M2 is activated when the MT 135 enters the cell C (Step 502). It is then determined in Step 5030 whether the MT 135 enters the regional communication area (R). The module M2 is now active and can help the controller 135-C determine whether the MT 135 is inside or outside the region (R). If the MT 135 enters the region (R), the module M1 is deactivated (Step 5031). The MT 135 optionally accesses the network 150b, using the module M2 (Step 5032). If it is determined in Step 5033 that the MT 135 has left the region (R), the module M1 is activated (Step 5034). The process then returns to Step 504.

Step 5032 in FIG. 5B may be replaced by Steps 50320-50323 in FIG. 5C when responding to a call from the network 150a while the MT 135 is in the region (R). When a call is placed from the network 150a to the MT 135 while the MT is in the region (R), the network 150a pages the MT 135 through the BTS 155c (Step 50320). When paging the MT 135, the network 150a obtains the location information of the MT 135 from the HLR. There will be no response from the MT 135 because the module M1 is deactivated. There are two ways to connect the call to the MT 135 located in the region (R). The network 150a may send an instruction to the MT 135 through the network 150b to get the module M1 activated (Step 50321). The call is thereby communicated to the MT 135, using the module M1 (Step 50322). When the call ends, the network 150a sends an instruction to the MT 135 to get the module M1 deactivated (Step 50323). When the call ends, the controller 135-C may deactivate the module M1. Alternatively, the network 150a may simply forward the call to the network 150b to communicate the call to the MT 135 through the network 150b, using the module M2. If it takes a while for the module M1 to becomes ready for communication, the communication is through the network 150b, using the module M2, until the module M1 becomes ready. When the module M1 becomes ready, the module M2 is switched to the module M1 to continue the communication. When the module M1 is activated in Step 50321, the module M2 may be deactivated, and when the module M1 is activated in Step 50323, the module M2 may be activated.

If a call has to be made from the MT 135 to the network 150a while the MT 135 is located in the region (R), the controller 135-C determines from the punched destination number that the call is directed to the network 150a and activates the module M1 to communicate the call to the network 150a. The call may be communicated to the network 150a through the network 150b without activating the module M1.

Returning to FIG. 5A, the MT 135 may initiates activation and deactivation of its module M2 by itself. To initiates activation and deactivation of its modules, the MT 135 has to have information on the locations of the communication areas formed by networks other than the network 150a. There are basically two ways to obtain such information. Such information may be pre-stored in the MT 135. Alternatively, the MT 135 may obtain such information from a target BTS at a hand-off. Thus, in the example shown in FIG. 4, information may be stored in the MT 135 that the regional communication area (R) is formed by the network 150b within the cell C of the BTS 155c. Or the MT 135 obtains such information from the BTS 155c at the time of the hand-off from the BTS 155b to the BTS 155c. Also, at each hand-off, the MT 135 determines if it has a communication module that can access any network that forms a regional communication area overlapping with the cell it is entering. Thus, at the hand-off from the BTS 155b to the BTS 155c, the MT 135 determines (Step 501) whether it has any module that can access the network 150b forming the region (R) within the cell C of the target BTS 155c. The module M2 is adapted to access the network 150b. It then activates the module M2 (Step 502). The module M2 is deactivated when the MT 135 hands off from the BTS 155c to another BTS (Steps 504 and 505).

The flowchart shown in FIG. 5A may again be used to describe the operations in which the network 150b initiates activation and deactivation of modules in the MT 135. To activate or deactivate modules in the MT 135, the network 150b has information on the locations of the communication areas formed by it and other networks. Thus, in FIG. 4, for instance, the network 150b has information that its regional communication area (R) is formed within the cell C of the BTS 155c of the network 150a. This information can be obtained and stored in the network 150b when the network 150b is built. There are a few ways available to obtain the location of the region (R). The location information may be obtained from the network operator of the network 150a. Given the geographical point of the region (R), the network operator of the network 150a can tell in which cell of its network the region (R) is located. Thus, the location information of the region (R) is obtain from the operator of the network 150b and stored in the network 150b when the network 150b is built. The location information of the region (R) can be obtained, using a test terminal adapted to access the network 150a. When the network 150b is built, the test terminal is placed inside or near the region (R) to communicate with the network 150b through the network 150a. A special test terminal can display the BTS number of the BTS that forms the cell in which the region (R) is located. The same information may be obtained from the HLR of the network 150a. The HLR maintains the location information of every active terminal registered with the network 150a. By obtaining the location information of the test terminal from HLR of the network 150a, the network 150b can determine in which cell of the network 150a the region (R) is located. In packets from the test terminal to the network 150b, the network 150a may include the BTS number of the BTS accessed by the test terminal. If the network 150a supports the 3.5 G or beyond, the packet includes the IP address of the BTS accessed by the test terminal. Therefore, from the packets from the test terminal, the network 150b can determine which cell of the network 150a the region (R) is located. These three methods are also used to update the location information of the region (R) when a new BTS of the network 150a is built near the region (R), or the existing BTSs surrounding the region (R) are moved or removed, or when any BTSs surrounding the region (R) change their identifications, i.e., their BTS numbers or IP addresses. If the location information of the region (R) is maintained in the HLR or other service nodes, the information is updated as well.

The network 150b also has information on the location of the MT 135.

There are some ways for the network 150b to obtain information on location of the MT 135. The simplest way to obtain the location information is, as explained above, to ask the network 150a when necessary. The network 150a obtains the location information from the HLR and send it back to the network 150b. The network 150b may obtain the location information directly from the MT 135. While traveling the communication area formed by the network 150a, the MT 135 may become necessary to make a call to the network 150b. The call is initiated by sending a first packet, usually a control packet requesting connection, through the currently communicating BTS 155 and through the network 150a to the network 150b. The MT 135 may include an identification of the currently communicating BTS in the first packet. The identification may be the BTS number of the BTS. The identification may be the IP address of the BTS if the network 100 supports the 3.5 G or beyond standards. Thus, when receiving the first packet from the MT 135, the network 150b learns the current location of the MT 135, i.e., in which cell of the network 150a the MT 135 is located.

Conversely, the network 150b may become necessary to make a call to the MT 135. A call from the network 150b is initiated by delivering a first packet from the network 150b to the network 150a. The network 150a obtains the information on the current location of the MT 135 from the HLR and delivers the packet to the MT 135 through the nearby BTS 155 that forms the cell in which the MT 135 is currently located. Upon receipt of the first packet, the MT 135 returns an ACK or NACK to the network 150b. The MT 135 may include the identification of the nearby BTS in the ACK or NACK. Or the network 150a may include the identification of the nearby BTS in the ACK or NACK. When receiving the ACK or NACK, the network 150b learns the current location of the MT 135.

Based on the location information obtained from the network 150a or the MT 135, the network 150b determines whether the MT is in the cell C (Step 501). If the MT is located in the cell C, the network 150b sends an instruction to the MT 135 through the network 150a. When receiving the instruction, the MT 135 activates the module M2 in the MT 135 (Step 502). The same methods are employed to determine whether the MT 135 has left the cell C (Step 504). If it is determined that the MT 135 has left the cell C, the network 150b sends an instruction to the MT through the network 150a to get the module M2 deactivated.

In the above embodiments, the first and second zones are defined in concurrence with the cell C. The zone may be defined by the sector(s) in the cell C in which the regional communication area (R) is located. Each BTS has three or six transmitters that transmit data at equal angular intervals and each form a fan-shaped sector. Each BTS has information on the locations of the MT located in its cell as to in which sectors they are found.

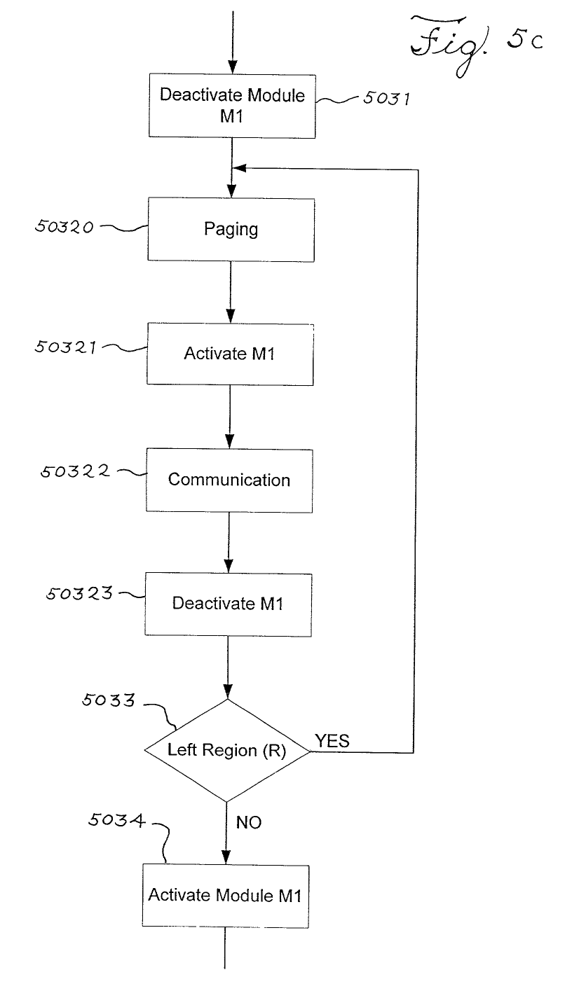

The zone may be defined by a group of neighboring cells. Generally, the zone may be defined by a chain of cells encompassing the region (R). In the example shown in FIG. 4, the smallest chain is defined by the cell C. In the example shown in FIG. 6 where the region (R) overlaps with three cells I, II and III, the smallest chain is defined by these cells I, II and III. Returning to FIG. 4, the zone may be defined by the adjacent cells surrounding the cell C. If so defined, the cell B is included in the zones. Thus, the module M2 of the MT 135 gets activated when the MT 135 enters the cell B. The zone may be defined narrowly within the adjacent cells. For instance, the zone may be defined by sectors in the surrounding cells that actually adjoin the cell C. In wireless cellular networks that support wideband code division multiple access (W-CDMA), cells are divided into group each controlled by a remote network controller (RNC). The zones may be defined by a group of neighboring cells, surrounding the cell C, controlled by one RNC.

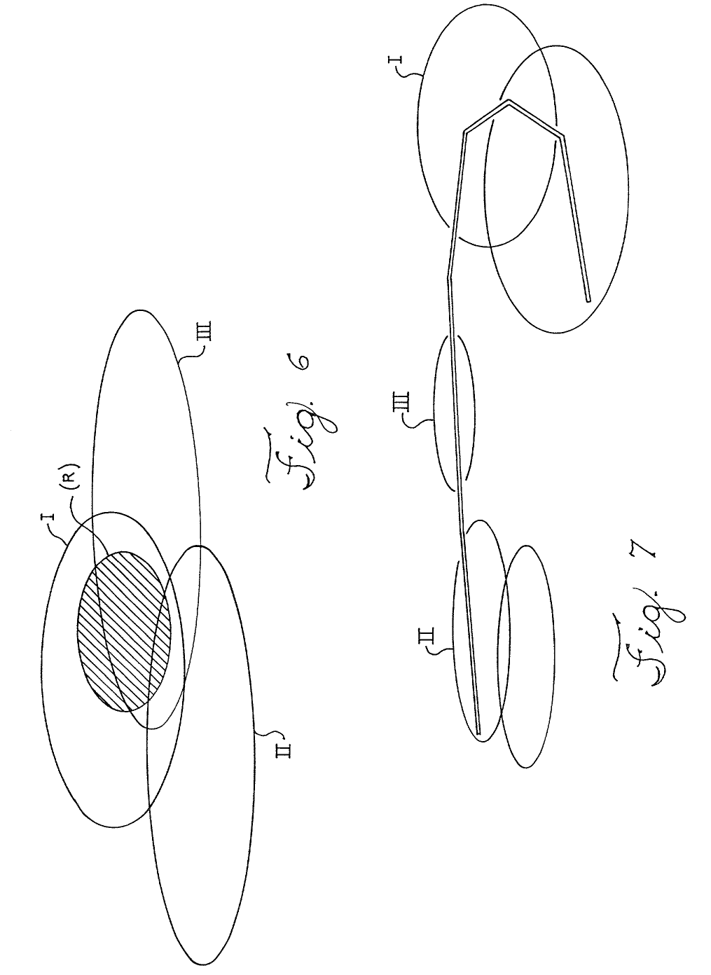

The first and second zones may be defined differently from each other. The second zone may be defined by a chain of cells encompassing the first zone. For instance, the first zone may be defined by the cell C, and the second zone may be defined by the adjacent cells surrounding the cell C. The first and second zones may be defined away from each other. For instance, in FIG. 7, the communication area I formed by the network 150a and the communication area II formed by the network 150b are located separately. Suppose that there is a third communication area III between the areas I and II. Suppose further that the MT 135 cannot get to the II from the area I without passing the third area III. In such an arrangement, the first zone may be defined by the third area III, and the second zone may be defined by the area II. Thus, the module M2 is activated when the MT 135 enters the third area III. The module M2 is deactivated when the MT 135 leaves the area II.

The zones may be defined by a closed loop encompassing the region (R). The loop does not have to accord with cells. The shape of the loop is determined based, for instance, on the shape of the regional communication area (R) and the geographical surroundings thereof. The loop may be circular concentrically with the region (R). Since the loop is defied without regard cells, the MT 135 has information on the geographical points of the loop and may need a GPS receiver to determine its location, i.e., whether it is entering or leaving the loop. The location of the MT 135 may be calculated, using the triangular geographical surveying method, based on signals received from three BTSs whose geographical locates are known to the MT 135.

Some of the modules in the MT 135 may be modules defined by software. Such a module consists of a simple hardware platform that can be configured by software to operate with different communication parameters and protocols. If the module M2 in the MT 135 is such a module defined by software, the module M2, at the time it is activated, should get loaded with the software for configuring the module to be able to access the network 150b. If the controller 135-C has the software, the controller loads the software on the module M2 when it activates the module. If the controller 135-C does not have the software, it may request to receive the software from wherever the software is downloadable. The software may be available from the network 150b though the network 150a. Along with the software, control information for communication with the network 150b is also downloaded to the MT 135. Such control information includes information on the air-interface protocol and parameters such as a radio bandwidth, a radio frequency, a coding rate, a modulation scheme, a bit rate and the like. If necessary, the information also includes information on an IP address with which the MT 135 is to be communicating with the network 150b. Some of the modules in the MT 135 may be modules defined by communication parameters. Such a module consists of hardware and software that can configure itself to communicate with different networks by giving it different communication parameters. The advantage of using such a module is that it does not require the entire communication software to be downloaded through communication but requires just parameters to be downloaded, thereby reducing communication overhead.

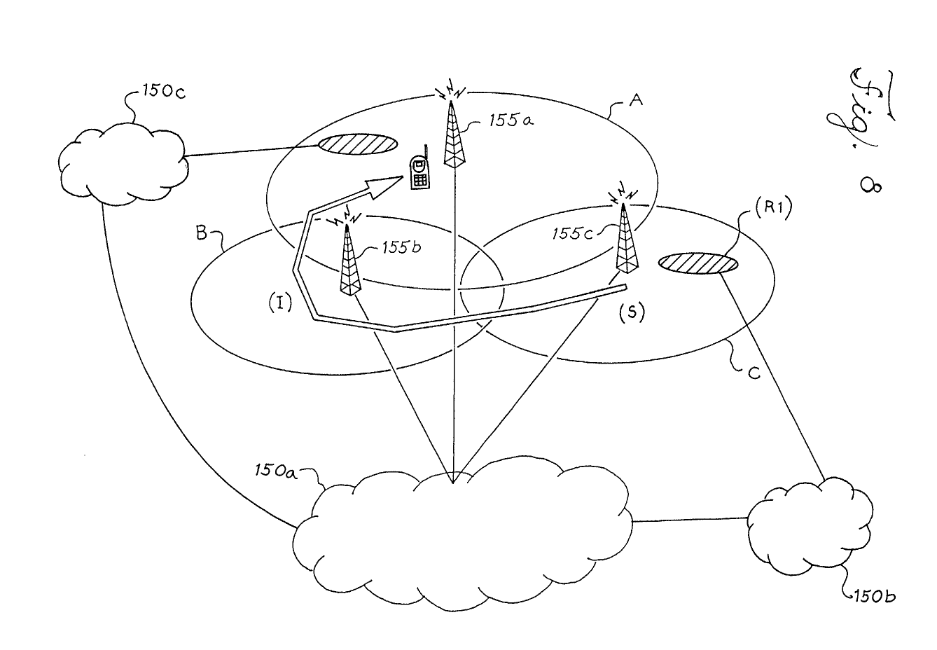

FIG. 8 shows another embodiment where a third network 150c is newly built which forms a new regional communication area (R2) in the cell A. The network 150c may be a private network for a different corporation, or it may be a part of the corporate network 150b and is built to cover a new business area in the cell A. In either case, the network 150c may employ the same communication parameters and protocol for communication as the network 150b does or may employ entirely different communication parameters and protocol than those of the network 150b. The networks 150c and 150a are connected with each other through a custom line or the Internet. If the network 150c is a part of the network 150b, the network 150c, instead of being connected to the network 150a, is connected to the network 150b though a custom line or through the Internet, using a virtual private network (VPN) created with a special encryption method.

The network 105c learns, using any one of the methods described above, that its region (R2) is located within the cell A of the network 150a. The network 105c communicates it to the networks 150a and 150b. Thus, both networks 150a and 150b know that the region (R2) is located in the cell A. Suppose that the network 150c employs the same communication parameters and protocol as those of the network 150b and thus the communication module M2 can be used to tap into the network 150c as well. Suppose further that the first and second zones are both defined by the cell A. As shown in FIG. 8, the MT 135 moves, staring from (S) through (I) and enters the destination (D), which is located in the cell A. Either network 150a or 150c can activate the module M2 when the MT 135 enters the cell A because they have the information that the region (R2) is located in the cell A. If the MT 135 initiates activation of the module M2, the MT has to have the same information. In the example shown in FIG. 8, the information is transmitted from the BTS 155a and stored in the MT 135 the when the MT 135 enters the cell A for the first time after the network 150c is installed.

Suppose that the network 150c employs different communication parameters and/or protocol. If the MT 135 has a module, say a module M3, which is adapted to access the network 150c, the module M3 is activated when the MT 135 enters the cell A. Also, the MT 135, if necessary, obtains from the BTS 155a the information that the region (R2) formed by the network 150c is located in the cell A. If the MT 135 does not have a module adapted to access the network 150c but has a module definable by software, it may, when entering the cell A, download software that can define the module as adapted to access the network 150c. If the MT 135 has a module that, given communication parameters, adapts itself to being able to access a different network, the MT 135 may download only the specific communication parameters that adapt the module to being able to access the network 150c.

Suppose that after the network 150c is built, the network 150b is removed. Before being removed, the network 150b notifies the networks 150a and 150c that it is being removed. Each of the networks 150a and 150c and the MT 135 updates its internal information and deletes the network 150b and its region (R1) from the memory. If the HLR of the network 150a maintains the information of the locations of the networks, the information in the HLR is updated. If the MT 135 maintains the information, the network 150a notifies the MT 135 that the network 150b has been removed, whereby the MT 135 updates the internal information. If the network 150c is a part of the network 150a, the network 150c, after the network 150b is removed, may notify the network 150a that the network 150b has been removed.

The identifications of some of the BTSs in the network 150a may be changed as a result of adding new BTSs, removing some of the BTSs or moving some of the BTSs. In the example shown in FIG. 4, if the identification of the BTS 155c is changed, the network 150a reports the new identification of the BTS 155c to the network 150b.

What have been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from its spirit. Accordingly, the scope of the invention is defined solely by the appended claims as properly interpreted.

1. A wireless communication system comprising:
(a) a plurality of communication networks operating with different communication parameters and protocols; and
(b) at least one communication terminal having multiple communication modules each adapted to operate with specific communication parameters and protocol for access to at least one corresponding communication network operating with the same communication parameters and protocol, wherein a module is activated to prepare for communication with the corresponding network when it is expected likely that the communication terminal is heading to access the corresponding network, whereas the activated module is deactivated when the same is expected unlikely.

2. A wireless communication system as defined in claim 1, wherein it is judged likely, when the communication terminal has entered a first predefined zone, that the communication terminal is heading to access the corresponding network, and the same is judged unlikely when the communication terminal has left a second predefined zone, wherein the first zone is defined such that it is reasonably inferred from the fact that the communication terminal has entered the first zone that the communication terminal is heading to access the corresponding network, and the second zone is defined such that it is reasonably inferred from the fact that the communication terminal is not heading to access the corresponding network.

3. A wireless communication system as defined in claim 2, wherein
each network forms at least one communication area comprised of a plurality of cells,
the first zone is defined by a chain of cells encompassing the communication area formed by the corresponding network, and
the second zone is defined by the same chain of cells or a chain of cells encompassing the first zone.

4. A wireless communication system as defined claim 3, wherein at least one of the first and second zones is defined by cells in networks that overlap with the communication area formed by the corresponding network.

5. A wireless communication system as defined in claim 4, wherein each cell is comprised of a plurality of sectors, and at least one of the first and second zones is defined by sectors in the cells that adjoin the communication area formed by the corresponding network.

6. A wireless communication system as defined in claim 3, wherein at least one of the first and second zones is defined by first cells adjacent to second cells in networks, the second cells overlapping with the communication area formed by the corresponding network.

7. A wireless communication system as defined in claim 6, wherein each cell is comprised of a plurality of sectors, and at least one of the first and second zones is defined by sectors in the first cells that adjoin the second cells.

8. A wireless communication system as defined in claim 2, wherein each network forms at least one communication area each comprised of a plurality of cells, and at least one of the first and second zones is defined by a group of cells being controlled collectively.

9. A wireless communication system as defined in claim 2, wherein at least one of the first and second zones is defined by a communication area of a network that lies on a route necessarily leading to the communication area formed by the corresponding network.

10. A wireless communication system as defined in claim 2, wherein at least one of the first and second zones is defined by a closed loop encompassing the communication area formed by the corresponding network.

11. A wireless communication system as defined in claim 2, it is determined whether the communication terminal is entering the first zone and/or leaving the second zone, based on information on the location of at least the first zone and information on the location of the communication terminal.

12. A wireless communication system as defined in claim 11, wherein the location information on at least the first zone is updated when the communication area formed by the corresponding network is changed and/or a new corresponding network is established.

13. A wireless communication system as defined in claim 11, wherein a network other than the corresponding network initiates at least activation of the module and has the information on the location of at least the first zone.

14. A wireless communication system as defined in claim 13, wherein at the time of a hand-off to the network by the communication terminal, the network obtains information that the communication terminal is equipped with the module.

15. A wireless communication system as defined in claim 11, wherein the communication terminal initiates at least activation of the module and has the location information on at least the first zone.

16. A wireless communication system as defined in claim 15, wherein the information is updated when the communication terminal for the first time enters the first zone for a newly build network or when an existing network is removed.

17. A wireless communication system as defined in claim 15, wherein the communication terminal obtains information on its location at the time of a hand-off thereby.

18. A wireless communication system as defined in claim 15, wherein the communication terminal has a GPS receiver to determine its location.

19. A wireless communication system as defined in claim 11, wherein the corresponding network initiates at least activation of the module and has the location information on at least the first zone.

20. A wireless communication system as defined in claim 19, wherein the corresponding network obtains information on the location of the communication terminal from the communication terminal.

21. A wireless communication system as defined in claim 20, wherein the corresponding network obtains information on the location of the communication terminal from a primary network of the communication terminal.

22. A wireless communication system as defined in claim 1, wherein at least one of the modules in the communication terminal is a communication module defined by software.

23. A wireless communication system as defined in claim 22, wherein the software is downloaded on the module when the module is activated.

24. A wireless communication system as defined in claim 1, wherein at least one of the modules in the communication terminal is a communication module defined by communication parameters.

25. A wireless communication system as defined in claim 24, wherein the communication parameters are downloaded on the module when the module is activated.

26. A wireless communication system as defined in claim 1, wherein if the communication terminal, after the module is activated, enters the communication area formed by the corresponding network, other modules that have been active are deactivated, and the deactivated modules are activated when the communication terminal has left the same communication area.

27. A wireless communication system as defined in claim 26, wherein while the other modules are deactivated, if a call is made to the communication terminal that requires one of the deactivated modules to be used to respond to, the requires module is activated to receive the call.
